(19) United States
(12) Patent Application Publication
(10) Pub. No.: US 2026/0303473 A1
(43) Pub. Date: Oct. 1, 2026

(54) Telemetry Reduction Using On-Device Small Language Models

(71) Applicant: Charter Communications Operating, LLC, St. Louis, MO (US)

(72) Inventors: Deependra RAWAT, Englewood, CO (US); Charles Ivan COOK, Castle Rock, CO (US)

(21) Appl. No.: 19/095,621

(22) Filed: Mar. 31, 2025

(51) Int. Cl. H04L 41/16; G06F 40/20; G06F 40/40; G06N 3/0495; G06N 3/08; H04L 41/14; H04L 43/04; H04L 43/065

(52) U.S. Cl. CPC H04L 41/16; G06F 40/20; G06F 40/40; G06N 3/0495; G06N 3/08; H04L 41/14; H04L 43/04; H04L 43/065

(57) ABSTRACT

Various embodiments include a method performed by a processing system in a network access device for reducing telemetry and logging data load in a network. The method may include receiving continuous telemetry and logging data from network functions and device health metrics of the access device and analyzing the continuous telemetry and logging data using a pre-trained small language model (SLM) instantiated in the processing system of the access device to select telemetry or logging data that should be reported to a remote server. Additionally, the method may include transmitting only the selected telemetry or logging data from the access device to the remote server.

### FIELD OF INVENTION

The present disclosure relates to network access devices, and more particularly to access devices that use on-device small language models to reduce telemetry and logging data load in networks.

### BACKGROUND

Network telemetry and logging functions on network access devices and the reporting of such data to network analytic platforms enable network service providers to monitor and maintain the health of modern communication networks. Network service providers collect and analyze data from various network access devices, including routers, switches, and wireless access points, to provide insights into network performance, security, and operational status. As networks have grown in complexity and scale, the volume of telemetry and logging data generated has increased exponentially, posing a growing burden on network service providers.

### SUMMARY

This summary is provided to introduce concepts of various aspects in a simplified form that are further described below in the detailed description. This summary is not intended to identify key or essential features of the claimed subject matter, nor is it intended to be used as an aid in determining the scope of the claims.

In various aspects, a method performed by a processing system in a network access device for reducing telemetry and logging data load in a network may include receiving telemetry and logging data from the access device, analyzing the telemetry and logging data as it is collected using a pre-trained small language model (SLM) instantiated in the processing system of the access device to select telemetry or logging data that should be reported to a remote server, and transmitting only the selected telemetry or logging data from the access device to the remote server. In some aspects, the SLM may be trained using a training dataset of simulated telemetry and logging data annotated with indications of telemetry and logging data that should be reported or should not be reported to the remote server. In some aspects, the SLM may be trained using a training dataset of historical telemetry and logging data annotated with indications of telemetry and logging data that should be reported or should not be reported to the remote server. In some aspects, the network access device may periodically receive an updated SLM from the remote server and instantiate the updated SLM in the processing system.

In some aspects, the SLM may be quantized during or after training to reduce its size before instantiating it in the processing system of the access device. In some aspects, the SLM may be trained to select for reporting telemetry or logging data that is indicative of a performance issue or a developing fault. In some aspects, the network access device may increase a frequency of transmitting selected telemetry or logging data when a performance issue or developing fault is detected. In some aspects, the network access device may reduce a frequency of transmitting redundant telemetry or logging data. In some aspects, the network access device may receive from the remote server an indication of particular telemetry or logging data that should not be reported, and suspend transmission of the indicated telemetry or logging data to the remote server.

Further aspects may include a network access device having a processing system configured with processor-executable instructions to perform operations corresponding to any of the methods summarized above. Further aspects may include a non-transitory processor-readable storage medium having stored thereon processor-executable instructions configured to cause a processing system to perform operations corresponding to any of the methods summarized above. Further aspects may include a network access device having various means for performing functions corresponding to any of the method operations summarized above.

### BRIEF DESCRIPTION OF THE FIGURES

The accompanying drawings, which are incorporated herein and constitute part of this specification, illustrate exemplary embodiments of the claims, and, together with the general description given and the detailed description, serve to explain the features herein.

FIG. 1 is a block diagram of a network system according to various embodiments.

FIG. 2 is a block diagram of a telemetry system in a network access device according to various embodiments.

FIG. 3 is a block diagram showing telemetry input and output of a small language model according to various embodiments.

FIG. 4A is an artificial neural network for processing telemetry and logging data according to various embodiments.

FIG. 4B is a neural network processing system for training a small language model according to various embodiments.

FIG. 4C is a backpropagation process in a neural network structure according to various embodiments.

FIG. 5 is a process flow diagram of a method for processing telemetry and logging data according to various embodiments.

FIG. 6 is a process flow diagram of a method for implementing and updating a small language model according to various embodiments.

FIG. 7 is a block diagram of an example of a server computing device suitable for implementing various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the claims.

Various embodiments include methods and network access devices for reducing telemetry and logging data load in networks using on-device small language models (SLMs). The small language model, instantiated in a processing system of a network access device, analyzes continuous and periodic telemetry and logging data as it is collected to select relevant information for reporting to a remote server. Since only selected relevant information may be reported to the remote server, the various embodiments may reduce data transmission and storage requirements while maintaining critical network monitoring capabilities.

Various embodiments may be implemented in various network access devices, such as residential gateways, cable modems, optical network units, amplifiers with streaming telemetry and logging capabilities (referred to herein as Smart Amplifiers), or wireless access points. The small language model may be trained on historical or simulated telemetry data, periodically updated from a remote server, and quantized to fit within device memory constraints, enabling efficient on-device processing of telemetry and logging data in resource-constrained devices.

The terms “computing system” and “computing device” are used herein to refer to (but not limited to) any one or all of servers, workstations, desktop computers, laptop computers, and other similar computing systems that include a memory for storing documents and neural network computational data, and a programmable processing system that may be configured to provide the functionality of various embodiments. The programmable processing system (sometimes referred to simply as “processing system”) may include neural network processors, such as graphical processing units, and neural network memory modules for running specialized LLM AI modules trained or fine-tuned according to various embodiments.

The term “processing system” is used herein to refer to one or more processors, including multi-core processors, graphics processing units (GPU), neural network processing units (NPU), microprocessor units (MPU), arithmetic logic units (ALU), memory systems, etc., that are organized and configured to perform computing functions of various embodiments as described herein.

The terms “neural network” and “neural network model” are used herein to refer to an interconnected group of processing nodes (or neuron models) that collectively operate as a software application or process that controls a function of a computing device and/or generates an overall inference result as output. Individual nodes in a neural network may attempt to emulate biological neurons by receiving input data, performing simple operations on the input data to generate output data, and passing the output data (also called “activation”) to the next node in the network. Each node may be associated with a weight value that defines or governs the relationship between input data and output data. A neural network may learn to perform new tasks over time by adjusting these weight values. In some cases, the overall structure of the neural network and/or the operations of the processing nodes do not change as the neural network learns a task. Rather, learning is accomplished during a “training” process in which the values of the weights in each layer are determined.

Telemetry and data logging systems in network access devices often transmit large volumes of data to remote servers for analysis, leading to increased network traffic, storage requirements, and operational costs. Such telemetry and logging data may be related to device health metrics (e.g., operating temperature, memory status, etc.) and network functions (e.g., connected devices, bandwidth, interference, jitter, etc.), which a network operator may use for monitoring network elements, local networks, and overall network operations. For ease of reference, the terms “telemetry and logging data” are used herein to refer generally to both device health and status information and information regarding a variety of network status and performance information.

Network access devices frequently lack the ability to intelligently filter and prioritize data at the source, resulting in the transmission of redundant or irrelevant information. Additionally, existing solutions may not adequately adapt to changing network conditions or emerging issues without manual intervention. Therefore, there is an unmet need for a network access device that can reduce telemetry and logging data load by performing on-device analysis and selection of relevant or important data for reporting to a network system, while maintaining the ability to identify and report critical network events and performance issues in real-time.

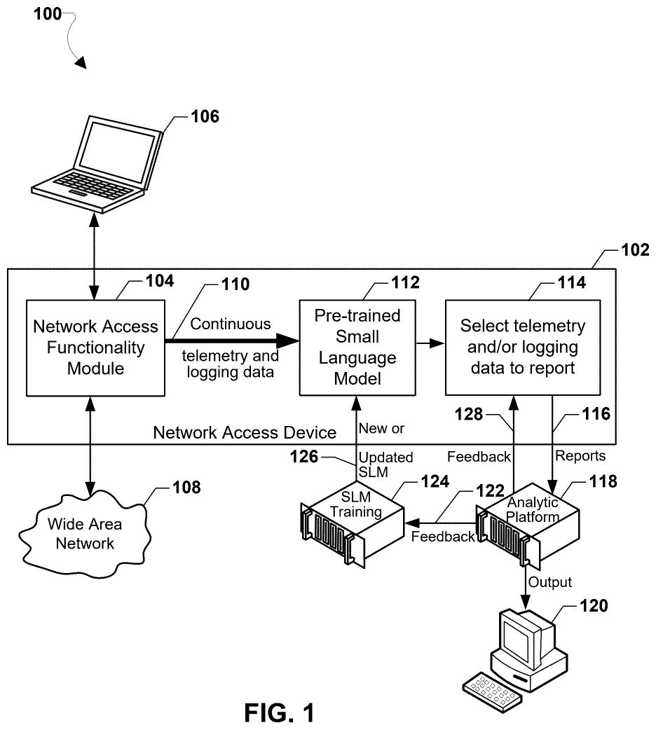

FIG. 1 illustrates a block diagram of a network system 100 including a network access device 102 that communicates with a networked device 106 (i.e., user device) and connects to a wide area network 108. In some embodiments, the network access device 102 may be one of a residential gateway, a cable modem, an optical network unit, Smart Amplifiers, or a wireless access point.

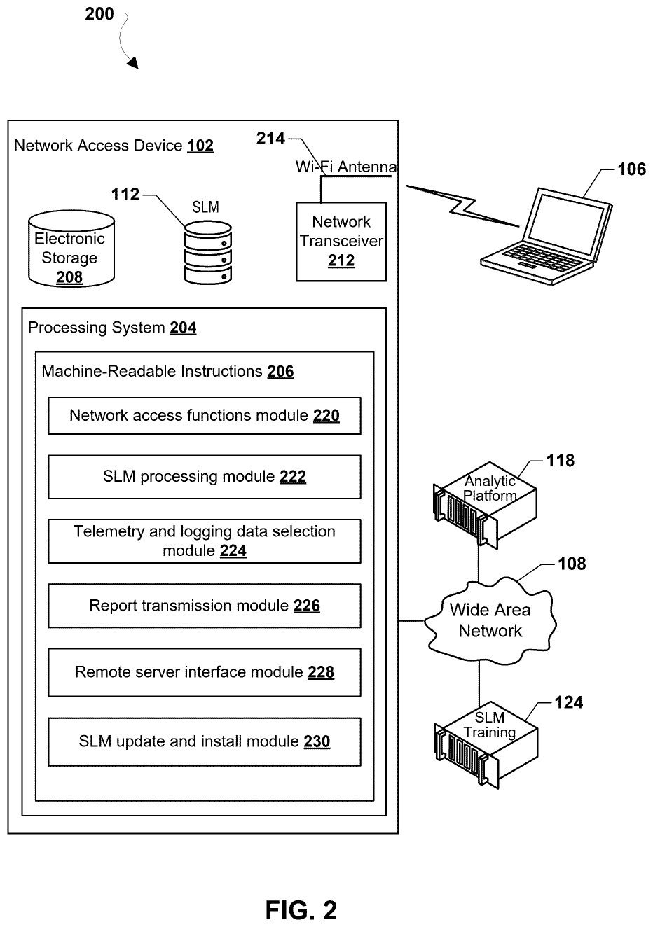

The network access device 102 may include a network access functionality module 104 that generates telemetry and logging data 110 while performing the functions of providing a local area network (LAN), such as, but not limited to, a WiFi LAN. The network access device 102 may also include a memory, a network transceiver, and a processing system coupled to the memory, network transceiver, and a network access functionality module 104 as described below with reference to FIG. 2.

The telemetry and logging data 110 may be processed by a small language model 112 within the network access device 102. The output from the small language model 112 may be provided to a data selection and reporting module 114, which generates data reports 116 that are transmitted to an analytic platform 118 executing on a remote server or in the Cloud.

The analytic platform 118 may process the received data reports 116 and provide outputs to network managers and technicians through an output terminal 120. Network managers and technicians may use the reported telemetry and logging data to monitor network performance, identify potential issues, optimize resource allocation, and proactively address developing faults or security concerns in the network infrastructure.

The analytic platform 118 may also generate feedback data 122 related to the types and usefulness of telemetry and logging data received from access devices, and provide such feedback to a model training module 124. The model training module 124 may use the feedback data 122 to generate a small language model update 126 that may be transmitted back to the network access device 102 to update the small language model 112. Thus, the system 100 may form a feedback loop in which network access devices 102 select from telemetry and logging data 110 flows that may be relevant or important information that is reported as generated data reports 116 to the analytic platform 118, which determines the types, formats and frequency of information that may be useful for managing network services and provides that feedback to a small model training system for use in finetuning and/or updating the small language model, The feedback may then sent in the form of small language model updates 126 to access devices 102. In this manner, various embodiments may improve the management of network services and equipment while reducing the amount of telemetry and logging data that is received, stored, and processed by the analytic platform.

In some embodiments, the analytic platform 118 may also be configured to provide feedback instructions 128 to network access devices 102 regarding telemetry and logging data reports. Such feedback instructions 128 may identify specific types of telemetry or logging data that is of particular interest or should be limited or not transmitted under certain network circumstances. For example, in the event of a network-wide event or issues (e.g., an earthquake, storm, local emergency, local or regional power outages, network attack, or a common equipment failure), the analytic platform 118 may send access devices feedback instructions to identify types of telemetry or data logging that would be useful in monitoring or remedying the situation. As another example, the analytic platform 118 may send access devices feedback instructions to limit or suspend reports of redundant information resulting from a network-wide event that would otherwise consume network resources without providing further useable information. In such embodiments the data selection and reporting module 114 may respond to feedback instructions 128, which may include prompting the small language model 112 to filter and summarize telemetry and logging data accordingly.

FIG. 2 illustrates a block diagram of a network system 200 illustrating components and software modules of a network access device 102 according to various embodiments. The network access device 102 may include a processing system 204 that is configured with machine readable instructions 206 that configure the processing system to perform various network access and data processing functions.

The network access device 102 may include electronic storage 208 for storing data and a network transceiver 212 coupled to a wireless antenna 214 for communicating with networked devices 106 and a wide area network 108, such as the Internet.

The machine readable instructions 206 may be organized into several software functionality modules, including a network access functions module 220, a small language model (SLM) processing module 222, a telemetry and logging data selection module 224 (also referred to as a data selection module 224), a report transmission module 226, a remote server interface module 228 (also referred to as a server interface module 228), and a small language model (SLM) update module 230.

The network access functions module 220 may include instructions to cause the processing system 204 to perform basic network connectivity functions of supporting LAN communications between networked devices 106 and remote servers (e.g., analytic platform 118 and SLM training server 124) via a wide area network 108.

The small language model processing module 222 may include instructions to cause the processing system 204 to perform operations including implementing the small language model 112 for analyzing the stream of telemetry and logging data 110 to select and/or summarize relevant or important information for reporting to the analytic platform 118.

The data selection module 224 may include instructions to cause the processing system 204 to selecting relevant telemetry and logging data based on the outputs received from the small language model 112. As described herein, the processing system 204 executing instructions in the small language model processing module 222 and the data selection module 224 may receive continuous and periodic telemetry and logging data 110 from the network access functions module 220 and device health monitoring sensors (e.g., temperature), and use the small language model 112 instantiated within the device to analyze the telemetry and logging data as it is collected to reduce the amount of information that is reported to the analytic platform 118 while ensuring relevant or important for maintaining the network and access devices is provided to the network's managers and technicians.

The report transmission module 226 may include instructions to cause the processing system 204 to handle the transmission of selected information reports to the analytic platform 118 using communication processes according to instructions in the server interface module 228. The processing system 204 may transmit only the selected telemetry or logging data from the network access device 102 to the analytic platform 118.

The small language model update module 230 may include instructions to cause the processing system 204 to receive updates to or replacements of the small language model 112 from the model training module 124 and instantiate the updated small language model 112 in memory, firmware, and/or machine readable instructions (e.g., small language model processing module 222) within the network access device 102.

The processing system 204 may execute these modules to implement the various embodiments to analyze telemetry and logging data 110 as it is collected using the locally-instantiated small language model 112, select relevant or important data for reporting, and transmit only the selected data to the network's analytic platform 118.

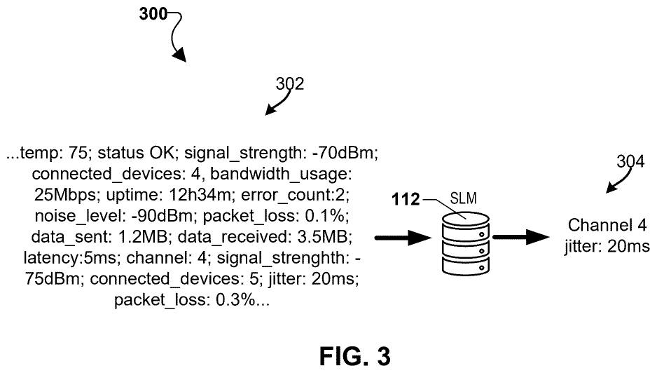

FIG. 3 illustrates a non-limiting example 300 of telemetry input to and summary data output by the small language model (SLM) 112. The diagram shows how a stream of the telemetry and logging data 302 (e.g., temp: 75; status OK; signal_strength: −70 dBm . . . ) may be input to the small language model 112 of the processing system for selection of information to report to an analytic platform. As described herein, the small language model 112 is trained to identify text, codes and patterns in collected input telemetry and logging data 302 that are relevant to or important for reporting to the analytic platform, and output (e.g., to the report transmission module 226) the model's selected text 304 (e.g., “channel 4 jitter: 20 ms”) based on its analysis of the input data stream. The diagram shows an example of how a stream of formatted data 302 may be processed by the small language model 112 to produce a much smaller amount of context and importance filtered output data 304 containing selected relevant or important text to report to the analytic platform.

In some embodiments, the small language model 112 may be implemented using one of several pre-trained language models, such as ALBERT, Mistral-7B, Gemma, or Llama3 8B. These models may be adapted and fine-tuned for the specific task of analyzing telemetry and logging data in network access devices.

The small language model 112 may be trained to efficiently process and analyze telemetry and logging data 110 as it is collected from device health sensors and generated by the network access functionality module 104 efficiently. As the data flows into the small language model 112, the model may apply its trained parameters to identify patterns, anomalies, and relevant information within the data stream. Given the limited vocabulary, structured patterns, and simplified syntax of access device telemetry and logging data (an example which is illustrated in FIG. 3), the size of the initially trained small language model may be modest compared to general large language models (e.g., ChatGPT). This may be because far fewer tokens may be needed to reflect the limited terms, values, and syntax of such telemetry and logging data than are required to encompass general knowledge and the extensive lexicon of natural language. Additionally, the syntactical complexity of access device telemetry and logging data that needs to be captured in a neural net may be a small fraction of the complexity reflected in natural language.

In some embodiments, to reduce the size of the small language model 112 and enable its implementation on resource-constrained network access devices, the model may be quantized during training, using Quantization Aware Training (QAT) methods, or after training, using post-training quantization (PTQ) methods. Quantization may involve reducing the precision of the model's parameters from higher-bit representations to lower-bit representations using known techniques. For example, the small language model 112 may be quantized to 8-bit, 4-bit, or 2-bit precision. This reduction in precision may significantly decrease the model size while maintaining acceptable levels of performance.

In some embodiments, the small language model 112 may be converted to TensorFlow Lite format to further reduce its size for embedding in device firmware. TensorFlow Lite is a lightweight framework designed for on-device machine learning inference, which may allow the small language model 112 to run efficiently on the processing system 204 of the network access device 102.

As the small language model 112 processes the incoming telemetry and logging data 110, the model may apply its learned parameters to identify important and relevant information. This may include detecting patterns indicative of performance issues, recognizing anomalies that could signal developing faults, or identifying critical status updates that require reporting.

The output of the small language model 112 may be a filtered and condensed or summarized version of the input telemetry and logging data, containing only the most relevant and important information for reporting to the network system analytic platform. This selected and/or summarized information may be used by the processing system executing the data selection and reporting module 114 for further processing (e.g., formatting) and transmission to the analytic platform 118.

By performing this initial analysis and filtering at the network access device 102, the use of the small language model 112 by the processing system may reduce the volume of data that needs to be transmitted and stored by the network operator and analytic platform dramatically. This may lead to reduced network traffic, lower storage requirements, and decreased operational costs associated with data management and analysis.

In some embodiments, the small language model 112 may be periodically updated through over-the-air (OTA) or over-the-network (OTN) updates from a remote server. These updates may incorporate refined model parameters resulting from further training or finetuning by a model trainer in a remote server based on feedback from the analytic platform 118. This ability to finetune and provide OTA/OTN updates to network access devices may allow the small language model to adapt to changing network conditions, new access devices, new access functionality, and improve network performance over time.

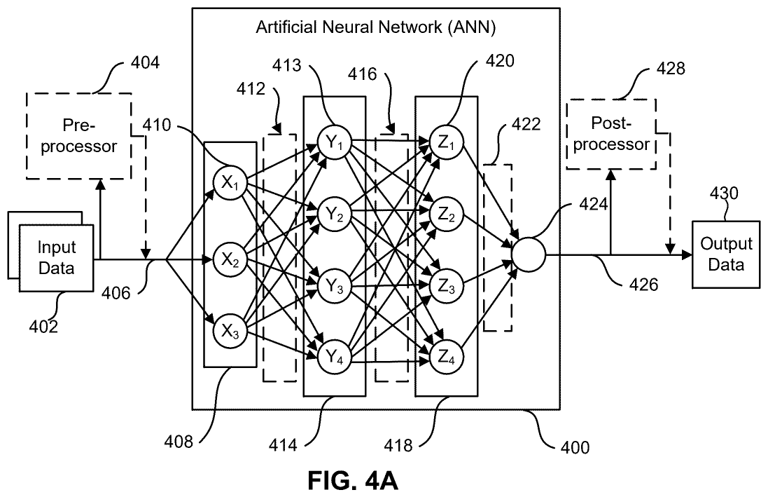

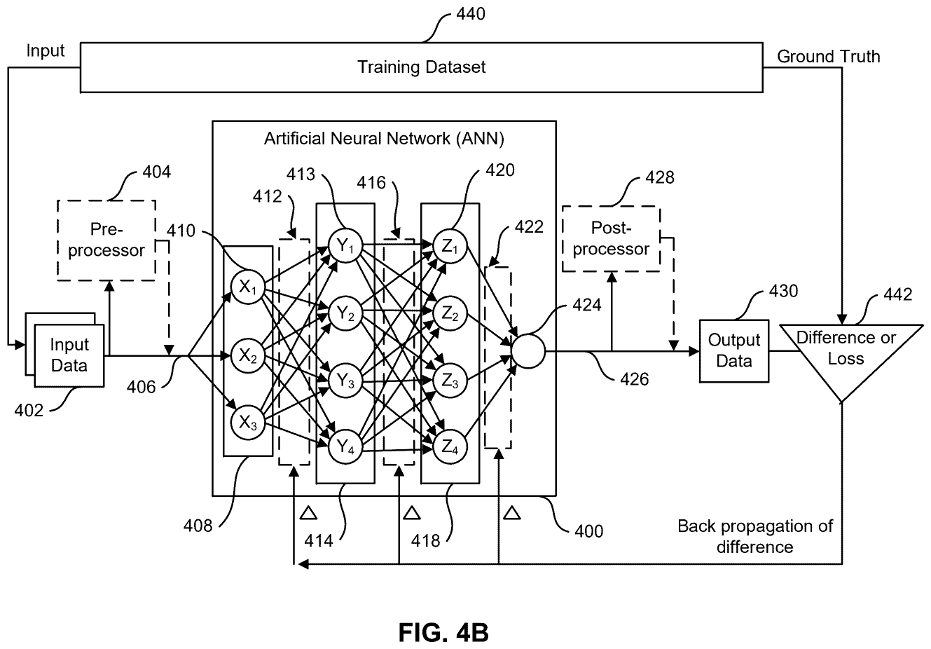

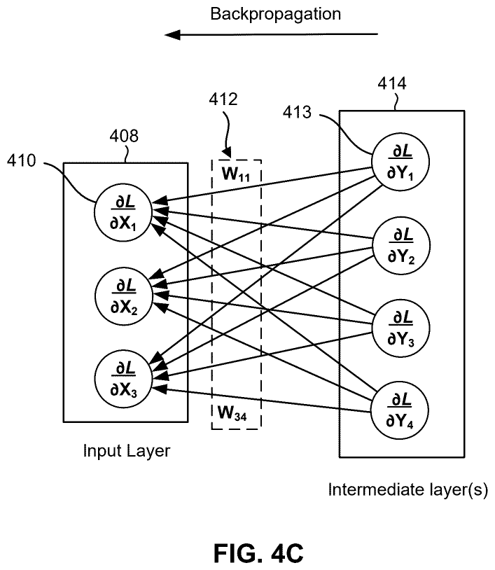

In some embodiments, the small language model 112 may be implemented using an artificial neural network 400, as illustrated in FIG. 4A. The neural network processing system 400 may receive input data 402, which may include telemetry and logging data 110 from the network access device 102. This input data 402 may be processed by the preprocessor module 404 to generate preprocessed input 406 suitable for processing by the neural network. The artificial neural network 400 may be specifically trained to process and analyze the telemetry and logging data 110 generated by the network access functionality module 104.

An artificial neural network 400 may include an input data source 402 that provides the telemetry and logging data 110 to an optional preprocessor module 404. A preprocessor module 404 may perform initial data formatting and normalization, generating optional preprocessed input 406 that is suitable for processing by the neural network.

The input 406 (or optional preprocessed input 406) may be fed into an input layer 408 of the artificial neural network 400. The input layer 408 may include multiple input nodes 410, each representing a specific feature or data point from the preprocessed input 406.

From the input layer 408, the data may flow through one or more intermediate layers 414. The connections between the input layer 408 and the intermediate layer 414 may be governed by input weights 412. These input weights 412 may determine the strength of connections between nodes in adjacent layers and may be adjusted during the training process to produce correct outputs from the neural network.

Each intermediate layer 414 may contain intermediate nodes 413 that process the weighted inputs received from the input layer 408. Each intermediate node 413 may apply an activation function to the sum of its weighted inputs, producing an output that is then passed to the next layer. Although FIG. 4A illustrates a single intermediate layer 414, additional intermediate layers may be implemented.

In some embodiments, the artificial neural network 400 may include multiple intermediate layers, such as an output intermediate layer 418. The connections between intermediate layers may be governed by intermediate weights 416, which function similarly to the input weights 412.

The output intermediate layer 418 may include output nodes 420 that connect to an output layer 424 through output weights 422. The output layer 424 may generate an inference output 426, which represents the network's analysis and selection of relevant telemetry and logging data.

The inference output 426 may be processed by an optional postprocessor module 428, which may format the output for use by other components of the network access device 102. The postprocessor module 428 may produce final output data 430, which may be used by the processor executing the data selection and reporting module 114 to generate data reports 116 for transmission to the analytic platform 118.

The artificial neural network 400 may process data in a feed-forward manner, with information flowing from the input layer 408 through the intermediate layers 414, 418 to the output layer 424. Each layer's nodes may perform computations based on inputs received from the previous layer and the corresponding weights.

The structure and operation of the artificial neural network 400 may enable the small language model 112 to efficiently process and analyze telemetry and logging data 110 as it is collected, selecting only the most relevant information for transmission to the analytic platform 118. This approach may reduce the volume of data transmitted over the wide area network 108 dramatically, while still maintaining the ability to identify and report critical network events and performance issues.

In some embodiments, the analytic platform 118 may use a large language model (LLM) to analyze the received telemetry and logging data 110 from a large number of network access devices. This large language model may have a more complex structure and greater computational resources compared to the small language model 112 implemented on the network access device 102. A large language model on the analytic platform 118 may perform more detailed analysis and generate outputs that can be used to improve the performance of the overall network and service access devices, as well as generate feedback to a model trainer for updating or finetuning the small language model for deployment in periodic updates as described.

FIG. 4B illustrates a training process for generating and fine-tuning an artificial neural network 400, such as used for the small language model 112. The weights 412, 416, 422 in the artificial neural network 400 may be adjusted during the training process to optimize the network's ability to identify and select relevant or important telemetry and logging data. This training process may involve using historical or simulated data with known relevance indicators to fine-tune the network's performance.

In some embodiments, the neural network processing system 400 may be trained using a training dataset 440. The training dataset 440 may include historical telemetry and logging data annotated with indications of telemetry and logging data that should be reported or should not be reported to the analytic platform 118. This annotated data may serve as the ground truth for training the small language model 112.

In some cases, the training dataset 440 may include simulated telemetry and logging data annotated with indications of telemetry and logging data that should be reported, throttled, or should not be reported to the analytic platform 118. This approach may allow the small language model to be trained on data for future access devices with new types of telemetry and logging data, enhancing adaptability to evolving network technologies.

During the training process, the preprocessed input 406 may be fed into the input layer 408, which may include input nodes 410. The data may flow through intermediate layers 414, which contain intermediate nodes 413, and then through the output intermediate layer 418, which may include output nodes 420. The connections between these layers may be governed by input weights 412, intermediate weights 416, and output weights 422 respectively.

The output layer 424 may generate an inference output 426, which may be processed by the postprocessor module 428 to produce output data 430. This output data 430 may represent the neural network's analysis and selection of relevant or important telemetry and logging data for reporting.

A difference module 442 may compare the output data 430 with the expected output from the training dataset 440. The difference module 442 may calculate the difference or loss between the neural network's output and the ground truth data. This difference may be used to adjust the weights 412, 416, 422 of the neural network through a process called backpropagation.

In some embodiments, the small language model may be trained to select for reporting telemetry or logging data that may be indicative of a performance issue or a developing fault. This training may enable the neural network processing system 400 to identify and prioritize critical information that may require immediate attention or further analysis by the analytic platform 118.

The training process may involve multiple iterations, with the weights 412, 416, 422 being adjusted after each iteration to minimize the difference between the neural network's output and the expected output from the training dataset 440. This iterative process may continue until the neural network achieves a desired level of accuracy in selecting relevant telemetry and logging data.

In some cases, the trained neural network may be quantized to reduce its size and computational requirements, allowing the trained neural network to run efficiently on the processing system 204 of the network access device 102. This quantization process may involve reducing the precision of the weights and activations, potentially from 32-bit floating-point values to 8-bit or even lower precision integers. Quantization may be performed during training using QAT training methods, or after the model has been trained using post-training quantization (PTQ) methods. In some embodiments, further size reduction may be accomplished by quantizing a model generated using QAT training methods.

The training process may enable the small language model 112 to efficiently process and analyze telemetry and logging data 110 as it is collected, selecting only the most relevant information for transmission to the analytic platform 118. This approach may reduce the volume of data transmitted over the wide area network 108 dramatically, while still maintaining the ability to identify and report critical network events and performance issues.

In some embodiments, the neural network processing system 400 may implement a backpropagation process to adjust the weights of the neural network, as illustrated in FIG. 4C. The backpropagation process may be used to compute gradients of the loss function with respect to the weights and propagate these gradients through the network to optimize the performance of the small language model 112.

FIG. 4C illustrates a simplified representation of the backpropagation process in the neural network structure. The diagram shows the input layer 408 connected to the intermediate layer 414 through weight connections. The input layer 408 may include input nodes 410 labeled as ∂L/∂X1, ∂L/∂X2, and ∂L/∂X3, while the intermediate layer 414 may contain intermediate nodes 413 labeled as ∂L/∂Y1, ∂L/∂Y2, ∂L/∂Y3, and ∂L/∂Y4.

The connections between the layers may be represented by weight connections, including a first weight connection W11 412 and extending to a last weight connection W34 412. These weight connections may form paths through which backpropagation calculations are performed. The direction of backpropagation is indicated by an arrow at the top of the diagram pointing from right to left.

During the backpropagation process, the neural network processing system 400 may compute gradients of the loss function (L) with respect to different nodes in the network. The partial derivatives represented at each node may indicate how the loss changes with respect to the values at that node. The weight connections 412 between the input layer 408 and intermediate layer 414 may allow for the propagation of these gradient values through the network structure.

The backpropagation process may begin by computing the gradient of the loss function with respect to the output of the neural network. This gradient may then be propagated backwards through the network, layer by layer, using the chain rule of calculus. At each layer, the gradient with respect to the layer's inputs may be computed based on the gradient with respect to the layer's outputs and the layer's weights.

For example, considering the connection between an input node Xi and an intermediate node Yⱼ, the gradient of the loss with respect to the weight Wᵢⱼ may be computed as:

$$\frac{\partial L}{\partial {W}_{i j}} = \frac{\partial L}{\partial {Y}_{j}} \cdot \frac{\partial {Y}_{j}}{\partial {W}_{i j}}$$

In this formula, ∂L/∂Yⱼ may be the gradient of the loss with respect to the output of node Yⱼ, and ∂Yⱼ/∂Wᵢⱼ may be the partial derivative of the output of node Yⱼ with respect to the weight Wᵢⱼ. The neural network processing system 400 may use these computed gradients to update the weights of the network. The weight update rule may typically follow the form:

$${W}_{i j}^{n e w} = {W}_{i j}^{o l d} - η \cdot \frac{\partial L}{\partial {W}_{i j}}$$

In this formula, n may be the learning rate, a hyperparameter that controls the size of the weight updates.

In some embodiments, the neural network processing system 400 may implement more advanced optimization algorithms, such as Adam or RMSprop, which may adapt the learning rate for each weight based on the history of gradient updates. Other advanced optimization algorithms are within the contemplated scope of disclosure.

The backpropagation process may be repeated for multiple iterations over the training dataset 440, allowing the neural network to gradually adjust the weights 412 to minimize the loss function and improve the performance of the small language model 112 in selecting relevant telemetry and logging data 110.

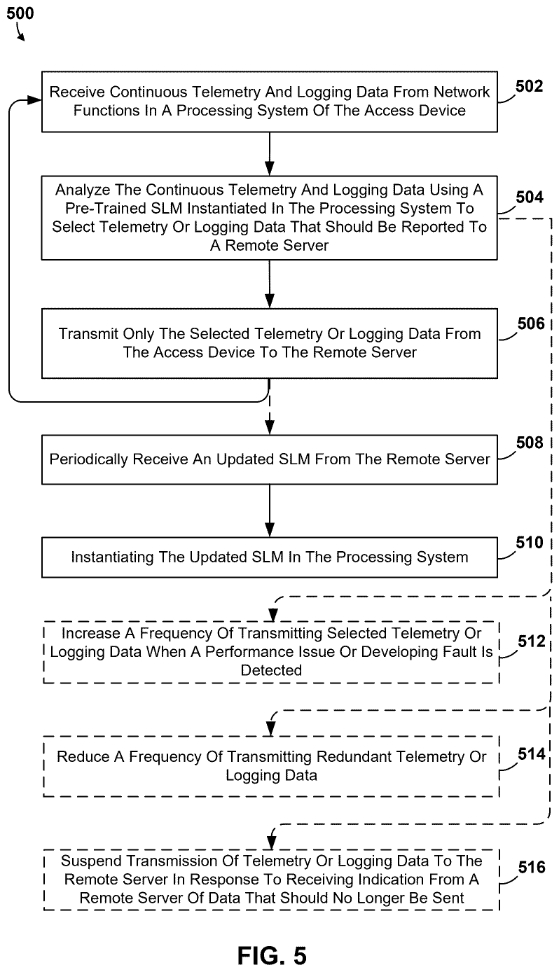

FIG. 5 illustrates a flowchart of a method 500 for processing telemetry and logging data in a network access device. With reference to FIGS. 1-5, the method 500 may be performed in a processing system (e.g., 204) on a network access device implementing software modules as described with reference to FIG. 2. Means for performing the functions of the operations in the method 500 may include a processing system 204 including one or more processors and other components (e.g., 206-230) described herein. Further, one or more processors of a processing system may be configured with software or firmware to perform some or all of the operations of the method 500. To encompass the alternative configurations enabled in various embodiments, the hardware implementing any or all of the method 500 is referred to herein as a “processing system.”

In block 502, the processing system 204 may receive continuous and periodic telemetry and logging data from network functions in the processing system 204 and periodic device health metrics (e.g., temperature, memory, etc.) of the network access device. This data may be generated by the processing system executing the network access functionality module and performing device health assessments during normal operation of the network access device 102.

In block 504, the processing system 204 may analyze the telemetry and logging data 110 as it is collected using a pre-trained small language model instantiated in the processing system to select telemetry or logging data that should be reported to the analytic platform. As described herein, the small language model may be designed to identify relevant and important information from a volume of telemetry and logging data.

In block 506, the processing system 204 may transmit only the selected telemetry or logging data from the network access device to an analytic platform. This selective transmission may reduce the volume of data sent over the wide area network dramatically.

In block 508, the processing system 204 may periodically receive an updated small language model from a remote server. These updates may incorporate new training data or refined model parameters, such as may be generated by a model trainer executing in the remote server using feedback information from the analytic platform.

In block 510, the processing system 204 may instantiate the updated small language model in the processing system 204. This operation may allow the network access device 102 to adapt to changing network conditions and improve its performance over time.

In some embodiments, the processing system 204 may increase a frequency of transmitting selected telemetry or logging data when a performance issue or developing fault is detected in optional block 512. This adaptive reporting may ensure that critical information is communicated promptly when needed. For example, in instances in which the small language model or the processing system recognizes that a performance issue or fault is developing, the processing system may increase how frequently information relevant to the recognized issue or fault are transmitted in reports to the analytic platform, thereby enabling the analytic platform and network managers to receive more information to manage or respond to the developing situation.

In some embodiments, the processing system 204 may reduce the frequency of transmitting redundant telemetry or logging data in optional block 514. In such embodiments, the processing system 204 may be configured (e.g., by the telemetry and logging data selection module 224) to keep track of the number and/or frequency of reports containing the same information are sent to the analytic platform, and reduce how often the same information is reported. This operation may further manage the volume of telemetry and logging data transmitted to the analytic platform by reducing or avoiding repetition of information. In some embodiments, rather than reducing the frequency of transmitting redundant data, the processing system 204 may begin to transmit summary reports (e.g., single symbols) indicating that the same condition continues to exist. In some embodiments, the processing system may send a report indicating that redundant reports will not be sent until a further notice, which may be a report that the condition is resolved and reporting that frequencies of the information involved will be sent in the future.

In some embodiments, the processing system 204 may suspend transmission of indicated telemetry or logging data to the analytic platform in response to receiving an indication from the analytic platform of data that should no longer be sent in optional block 516. This feature may allow the network system 100 to dynamically adjust the reporting of telemetry and logging data from access devices based on the current needs of the network system. In the operations in optional block 516, the processing system 204 may receive from a remote server (e.g., the server or cloud implementing the analytic platform 118) an indication of particular telemetry or logging data that should not be reported, and suspend transmission of the indicated telemetry or logging data to the remote server. For example, in the event of a large scale event, such as a storm, earthquake, or solar flare, a large number of access devices 102 may send the same fault or performance information to analytic platform simultaneously and repeatedly. In such a situation, the analytic platform 118 does not need to receive the same information repeatedly, and would benefit from receiving different relevant or important information. This embodiment enables the analytic platform 118 to stop or throttle reports of information the system 100 does not need, thereby saving transmission and storage resources while ensuring the other information that may be of importance is transmitted by access devices.

In some embodiments, the processing system 204 may include adjusting reporting frequency based on detected events or time of day. For example, the processing system 204 may increase reporting frequency during peak usage hours or when specific network events are detected.

In some cases, the processing system 204 may utilize event-based or condition-based telemetry reporting. The processing system 204 may trigger data transmission based on specific events or conditions detected in the network access device 102, rather than relying solely on periodic reporting.

The method 500 may enable efficient processing and transmission of telemetry and logging data by network access devices 102, reducing the data load on the network system 100 while maintaining the ability to identify and report critical network events and performance issues.

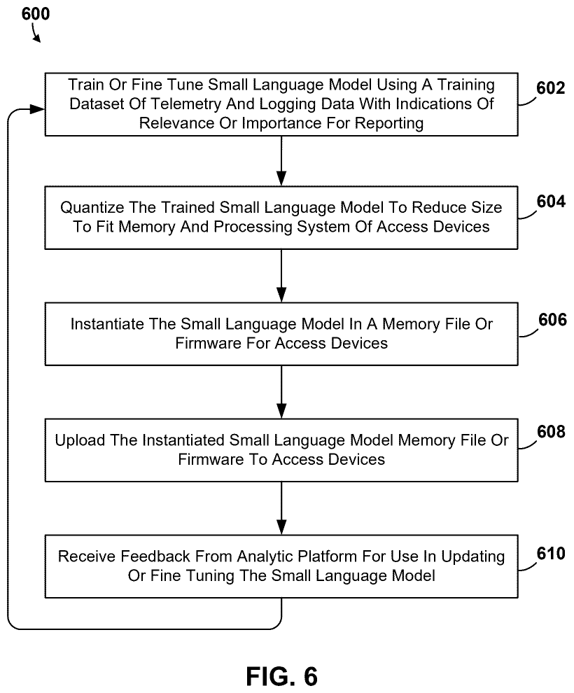

FIG. 6 is a process flow diagram of a method 600 for generating and updating a small language model by a model trainer executing on a remote server (e.g., SLM training server 124).

In block 602, the remote server may perform training or fine-tuning a small language model using a training dataset of telemetry and logging data with indications of relevance or importance for reporting, such as described with reference to FIGS. 4A-4C. The training dataset may include historical telemetry and logging data collected from different types of network access devices 102 and annotated to indicate relevance and/or importance for reporting. In some embodiments, the training dataset may include simulation-generated training data based on known access device functionality and firmware.

In block 604, the remote server may perform operations including using known methods of quantizing the trained small language model to reduce its size to fit within the memory and processing system constraints of access devices. Quantization may involve reducing the precision of the model's parameters, such as weights and biases, from higher-bit representations (e.g., 32-bit floating-point) to lower-bit representations (e.g., 8-bit integers).

In some embodiments, the operations in block 602 and 604 may be performed simultaneously using QAT training methods. Further size reduction may be accomplished by quantizing the model after QAT training.

In block 606, the remote server may instantiate the quantized small language model in a memory file or firmware for implementation in access devices. This operation may involve converting the quantized model into a format suitable for embedding in device firmware, such as TensorFlow Lite format. The converted model may be packaged with the necessary runtime libraries and dependencies to enable execution on the processing system of network access devices.

In block 608, the remote server may include uploading the instantiated small language model memory file or firmware to access devices. This operation may be performed as part of an OTA or OTN firmware update process for network access devices. For example, an updated small language model may be transmitted over the wide area network to the network access devices 102, where the processing system 204 may execute a small language model update module 230 to manage the installation and integration of the updated model.

In block 610, the remote server may receive feedback from an analytic platform 118 for use in updating or fine-tuning the small language model. The feedback data may be based on an analysis of data reports received from multiple network access devices 102. This feedback may include information about the accuracy and relevance of the selected telemetry and logging data, as well as indications of new patterns or types of data that should be prioritized for reporting. The remote server may use the feedback to retrain or finetune the small language model in block 602 and repeat the method 600 to update or the small language model instantiated in network access devices. As described herein, this iterative process may adapt the small language model to changing network conditions, emerging issues, new access devices, and evolving telemetry requirements and formats over time.

In some embodiments, the method 600 may include additional operations for monitoring the performance of the small language model on the network access devices. The processing system 204 may collect metrics on the model's efficiency, accuracy, and impact on device resources. These metrics may be included in the telemetry and logging data 110 sent to the analytic platform 118 for analysis and potential incorporation into future model updates.

The method 600 may enable continuous improvement of the small language model's ability to select relevant telemetry and logging data for reporting. By iteratively training, deploying, and refining the model based on real-world performance and feedback, the network system 100 may maintain a balance between reducing data load and ensuring important information is communicated to the analytic platform 118.

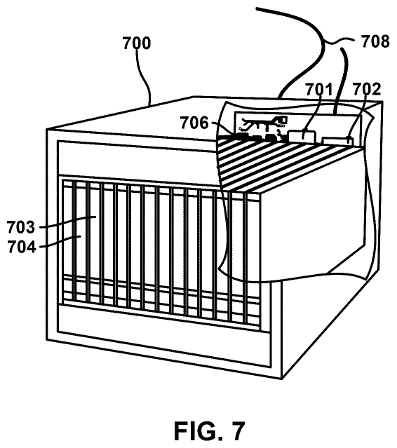

FIG. 7 illustrates a perspective view of a server 700 suitable for implementing various embodiments. The server 700 may include a processing system 701 and memory 702. The processing system 701 may execute instructions stored in the memory 702 to perform various functions related to various embodiments.

A storage module 703 may include multiple storage slots 704 to accommodate storage devices that store information such as received reports of telemetry and logging data, and/or parameters defining the small language model of various embodiments.

The server 700 may also include a network interface 706 that connects to a network connection 708, enabling communication with other devices such as the access point via a wide area network (e.g., the Internet).

Implementation examples are described in the following paragraphs. While some of the following implementation examples are described in terms of example methods, further example implementations may include: the example methods discussed in the following paragraphs implemented by a computing system including a processing system configured (e.g., with processor-executable instructions) to perform operations of the methods of the following implementation examples; and the example methods discussed in the following paragraphs may be implemented as a non-transitory processor-readable storage medium having stored thereon processor-executable instructions configured to cause a processing system of a computing system to perform the operations of the methods of the following implementation examples.

Example 1: A method performed by a processing system in a network access device for reducing telemetry and logging data load in a network, including: receiving, by the processing system, telemetry and logging data from the access device; analyzing the telemetry and logging data as it is received using a pre-trained small language model (SLM) instantiated in the processing system of the access device to select telemetry or logging data that should be reported to a remote server; and transmitting only the selected telemetry or logging data from the access device to the remote server.

Example 2: The method of example 1, wherein the SLM is trained using a training dataset of simulated telemetry and logging data annotated with indications of telemetry and logging data that should be reported or should not be reported to the remote server.

Example 3: The method of any of examples 1-2, wherein the SLM is trained using a training dataset of historical telemetry and logging data annotated with indications of telemetry and logging data that should be reported or should not be reported to the remote server.

Example 4: The method of any of examples 1-3, further including: periodically receiving an updated SLM from the remote server; and instantiating the updated SLM in the processing system.

Example 5: The method of any of examples 1-4, wherein the SLM is quantized during or after training to reduce its size before instantiating it in the processing system of the access device.

Example 6: The method of any of examples 1-5, wherein the SLM is trained to select for reporting telemetry or logging data that is indicative of a performance issue or a developing fault.

Example 7: The method of any of examples 1-6, further including increasing a frequency of transmitting selected telemetry or logging data when a performance issue or developing fault is detected.

Example 8: The method of any of examples 1-7, further including reducing a frequency of transmitting redundant telemetry or logging data.

Example 9: The method of any of examples 1-8, further including: receiving from the remote server an indication of particular telemetry or logging data that should not be reported; and suspending transmission of the indicated telemetry or logging data to the remote server.

As used in this application, terminology such as “unit,” “component,” “module,” “system,” etc., is intended to encompass a software-implemented or computer-related entity. These entities may involve, among other possibilities, hardware, firmware, a blend of hardware and software, software alone, or software in an operational state. As examples, a component may encompass a running process on a processor, the processing system itself, an object, an executable file, a thread of execution, a program, or a computing device. To illustrate further, both an application operating on a computing device and the computing device itself may be designated as a component. A component might be situated within a single process or thread of execution or could be distributed across multiple processors or cores. In addition, these components may operate based on various non-volatile computer-readable media that store diverse instructions and/or data structures. Communication between components may take place through local or remote processes, function or procedure calls, electronic signaling, data packet exchanges, and memory interactions, among other known methods of network, computer, processor, or process-related communications.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the methods may be substituted for or combined with one or more operations of the methods.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an,” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

A number of different types of memories and memory technologies are available or contemplated in the future, any or all of which may be included and used in systems and computing devices that implement the various embodiments.

In one or more embodiments, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include random access memory (RAM), read-only memory (ROM), electrically erasable programmable read-only memory (EEPROM), FLASH memory, solid-state drives (SSD), non-volatile memory express (NVMe) drives, or any other medium that may be used to store program code in the form of processor-executable instructions or data structures and that may be accessed by a processor of a computing device. Modern technologies, such as cloud-based storage solutions, including infrastructure-as-a-service (IaaS) platforms, may offer scalable and distributed options for storing and accessing program code.

In addition, the operations of a method or algorithm may reside as one or any combination or set of codes and/or instructions on a non-transitory processor-readable medium and/or computer-readable medium, which may be incorporated into a computer program product. Emerging technologies, including quantum computing storage media and blockchain-based storage solutions, may further enhance data integrity and security. Artificial intelligence (AI) and machine learning (ML)-optimized hardware accelerators, such as graphical processing systems (GPUs) and tensor processing systems (TPUs), may be used to execute complex algorithms.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

We claim:

1. A method performed by a processing system in a network access device for reducing telemetry and logging data load in a network, comprising:
receiving, by the processing system, telemetry and logging data from the access device;
analyzing the telemetry and logging data as it is received using a pre-trained small language model (SLM) instantiated in the processing system of the access device to select telemetry or logging data that should be reported to a remote server; and
transmitting only the selected telemetry or logging data from the access device to the remote server.

2. The method of claim 1, wherein the SLM is trained using a training dataset of simulated telemetry and logging data annotated with indications of telemetry and logging data that should be reported or should not be reported to the remote server.

3. The method of claim 1, wherein the SLM is trained using a training dataset of historical telemetry and logging data annotated with indications of telemetry and logging data that should be reported or should not be reported to the remote server.

4. The method of claim 3, further comprising:
periodically receiving an updated SLM from the remote server; and
instantiating the updated SLM in the processing system.

5. The method of claim 3, wherein the SLM is quantized during or after training to reduce its size before instantiating it in the processing system of the access device.

6. The method of claim 1, wherein the SLM is trained to select for reporting telemetry or logging data that is indicative of a performance issue or a developing fault.

7. The method of claim 6, further comprising increasing a frequency of transmitting selected telemetry or logging data when a performance issue or developing fault is detected.

8. The method of claim 1, further comprising reducing a frequency of transmitting 1 redundant telemetry or logging data.

9. The method of claim 1, further comprising:
receiving from the remote server an indication of particular telemetry or logging data that should not be reported; and
suspending transmission of the indicated telemetry or logging data to the remote server.

10. A network access device, comprising:
a memory;
a network transceiver;
a network access functions module; and
a processing system coupled to the memory, network transceiver, and the network access functions module, wherein the processing system includes a pre-trained small language model (SLM) and is configured to perform operations comprising:
receiving telemetry and logging data;
analyzing the telemetry and logging data using the SLM to select telemetry or logging data that should be reported to a remote server; and
transmitting only the selected telemetry or logging data to the remote server.

11. The network access device of claim 10, wherein the network access device is one of a residential gateway, a cable modem, an optical network unit, Smart Amplifiers, or a wireless access point.

12. The network access device of claim 10, wherein the SLM is trained using a training dataset of simulated telemetry and logging data annotated with indications of telemetry and logging data that should be reported or should not be reported to the remote server.

13. The network access device of claim 10, wherein the SLM is trained using a training dataset of historical telemetry and logging data annotated with indications of telemetry and logging data that should be reported or should not be reported to the remote server.

14. The network access device of claim 13, wherein the processing system is further configured to perform operations comprising:
periodically receiving an updated SLM from the remote server; and
instantiating the updated SLM in the processing system.

15. The network access device of claim 13, wherein the SLM is quantized during or after training to reduce its size before instantiating it in the processing system of the access device.

16. The network access device of claim 10, wherein the SLM is trained to select for reporting telemetry or logging data that is indicative of a performance issue or a developing fault.

17. The network access device of claim 16, wherein the processing system is further configured to perform operations comprising increasing a frequency of transmitting the selected telemetry or logging data when a performance issue or developing fault is detected.

18. The network access device of claim 10, wherein the processing system is further configured to perform operations comprising reducing a frequency of transmitting redundant telemetry or logging data.

19. The network access device of claim 10, wherein the processing system is further configured to perform operations comprising:
receiving from the remote server an indication of particular telemetry or logging data that should not be reported; and
suspending transmission of the indicated telemetry or logging data to the remote server.

20. A non-transitory processor-readable medium having stored thereon processor-executable instructions configured to cause a processing system of a network access device to perform operations comprising:
receiving telemetry and logging data from the access device;
analyzing the telemetry and logging data as it is received using a pre-trained small language model (SLM) instantiated in the processing system to select telemetry or logging data that should be reported to a remote server; and
transmitting only the selected telemetry or logging data from the access device to the remote server.
